(19) United States
(12) Patent Application Publication
(10) Pub. No.: US 2022/0314994 A1
(43) Pub. Date: Oct. 6, 2022

(54) PULL-OVER CONTROL APPARATUS, VEHICLE, AND PULL-OVER CONTROL METHOD

(71) Applicant: Panasonic Intellectual Property Management Co., Ltd., Osaka (JP)

(72) Inventor: Ichiro YAMANE, Kanagawa (JP)

(73) Assignee: Panasonic Intellectual Property Management Co., Ltd., Osaka (JP)

(21) Appl. No.: 17/848,019

(22) Filed: Jun. 23, 2022

Related U.S. Application Data
(63) Continuation of application No. PCT/JP2020/040191, filed on Oct. 27, 2020.

(30) Foreign Application Priority Data
Dec. 26, 2019 (JP) 2019-236226

(51) Int. Cl. B60W 30/18; G06V 20/58; G08G 1/16; B60W 50/02

(52) U.S. Cl. CPC B60W 30/18009; G06V 20/58; G08G 1/16; B60W 50/0205; B60W 2554/00; B60W 2520/10; B60W 2520/06

(57) ABSTRACT

A pull-over control apparatus includes: an input that receives information on a pull-over area determined as a pull-over destination for a vehicle present on a roadway and information on an object recognized in the pull-over area; and a controller that recognizes the pull-over area while dividing the pull-over area into a plurality of partial areas, based on the information on the pull-over area, the plurality of partial areas including at least a first partial area closest to the vehicle and a second partial area adjacent to the first partial area, the controller controlling, based on the information on the object, the vehicle so that the vehicle is pulled over to a first range where pull-over of the vehicle is possible among the plurality of the partial areas.

### TECHNICAL FIELD

The present disclosure relates to a pull-over control apparatus that controls traveling of a vehicle for pull-over, a vehicle, and a pull-over control method.

### BACKGROUND ART

Conventionally, a function of safely pulling over a vehicle that has difficulty continuing automated driving has been developed. This function is called, for example, a minimum risk maneuver (MRM).

For example, Patent Literature (hereinafter, referred to as “PTL”) 1 discloses an apparatus that, when pulling over a subject vehicle to the road shoulder, controls the speed of the subject vehicle so that another vehicle located around the subject vehicle can pass the subject vehicle, and moves the subject vehicle to the road shoulder after another vehicle passes the subject vehicle.

### CITATION LIST

### Patent Literature

PTL 1

Japanese Patent Application Laid-Open No. 2018-144720

### SUMMARY OF INVENTION

### Solution to Problem

A pull-over control apparatus according to the embodiment of the present disclosure includes: an input that receives information on a pull-over area determined as a pull-over destination for a vehicle present on a roadway and information on an object recognized in the pull-over area; and a controller that recognizes the pull-over area while dividing the pull-over area into a plurality of partial areas, based on the information on the pull-over area, the plurality of partial areas including at least a first partial area closest to the vehicle and a second partial area adjacent to the first partial area, the controller controlling, based on the information on the object, the vehicle so that the vehicle is pulled over to a first range where pull-over of the vehicle is possible among the plurality of the partial areas.

A vehicle according to the embodiment of the present disclosure includes the pull-over control apparatus according to the embodiment of the present disclosure.

A pull-over control method according to the embodiment of the present disclosure includes: receiving information on a pull-over area determined as a pull-over destination for a vehicle present on a roadway and information on an object recognized in the pull-over area;

recognizing the pull-over area while dividing the pull-over area into a plurality of partial areas based on the information on the pull-over area, the plurality of partial areas including at least a first partial area closest to the vehicle and a second partial area adjacent to the first partial area; and controlling, based on the information on the object, the vehicle so that the vehicle is pulled over to a range where pull-over of the vehicle is possible among the plurality of the partial areas.

### Advantageous Effects of Invention

According to the present disclosure, it is possible to reduce the cost.

### BRIEF DESCRIPTION OF DRAWINGS

FIG. 1 is a block diagram illustrating an exemplary configuration of a vehicle and a pull-over control apparatus according to an embodiment of the present disclosure;

FIG. 2 is a schematic top-view of an example of a pull-over area according to the embodiment of the present disclosure;

FIG. 3 is a schematic top-view of an example of a plurality of partial areas according to the embodiment of the present disclosure;

FIG. 4 is a schematic top-view of another example of the plurality of partial areas according to the embodiment of the present disclosure;

FIG. 5 is a schematic top-view of still another example of the plurality of partial areas according to the embodiment of the present disclosure;

FIG. 6 is a schematic top-view of a case where an object is present in a first partial area;

FIG. 7 is a schematic top-view of a case where an object is present in a second partial area;

FIG. 8 is a schematic top-view of a case where an object is present in a third partial area;

FIG. 9 is a flowchart of an example of an operation flow of the pull-over control apparatus according the embodiment of the present disclosure; and

FIG. 10 is a diagram illustrating a hardware configuration of a computer that realizes each function by a program.

### DESCRIPTION OF EMBODIMENT

Hereinafter, an embodiment of the present disclosure will be described with reference to the drawings. Components that are common to the drawings are denoted by the same reference numerals, and their descriptions are omitted as appropriate.

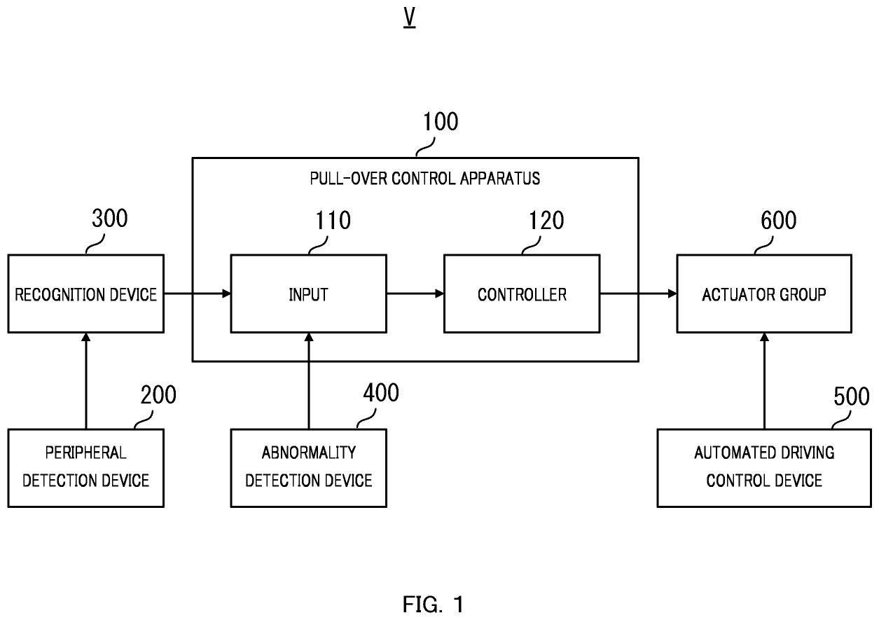

First, a configuration of vehicle V and pull-over control apparatus 100 according to the embodiment will be described with reference to FIG. 1. FIG. 1 is a block diagram illustrating an exemplary configuration of vehicle V and pull-over control apparatus 100 according to the embodiment.

Vehicle V is an automobile that performs automated driving (may be a passenger vehicle or a commercial vehicle).

As illustrated in FIG. 1, vehicle V includes pull-over control apparatus 100, peripheral detection device 200, recognition device 300, abnormality detection device 400, automated driving control device 500, and actuator group 600.

Peripheral detection device 200 is a device that detects the peripheral environment of vehicle V (e.g., the environment in the longitudinal and lateral direction of vehicle V). As peripheral detection device 200, a sensing camera, a laser sensor, and/or a millimeter-wave radar can be used, for example. Peripheral detection apparatus 200 outputs the peripheral environment information as a detection result to recognition apparatus 300. Note that, since the detection technique by peripheral detection device 200 is a publicly known technique, a detailed description thereof is omitted.

Recognition device 300 is a device that recognizes (may be referred to as determine) a pull-over area based on the peripheral environment information received from peripheral detection device 200, and recognizes an object (e.g., a pedestrian, a bicycle, or the like) present in the pull-over area. Note that the current position of vehicle V is known to recognition device 300.

The pull-over area is an area where vehicle V that has difficulty continuing automated driving is pulled over for evacuation. The pull-over area includes, for example, an area including at least one of a road shoulder, a portion of a roadway facing the road shoulder, a sidewalk, a bicycle road, a bicycle and pedestrian road, a partitioned parking space, and/or the like. However, the pull-over area is not limited to the above, and may be an area where vehicle V can enter and does not completely obstruct the passage of another vehicle or the like.

In the recognition process performed by recognition device 300, for example, pattern matching or clustering is used in accordance with the information of the detection result. Note that, since the recognition technique by recognition device 300 is a publicly known technique, a detailed description thereof is omitted.

Recognition device 300 outputs the pull-over area information and the object information as the detection result to pull-over control apparatus 100.

The pull-over area information includes, for example, information such as a relative position of the pull-over area with respect to vehicle V, a shape of the pull-over area, and a size (area) of the pull-over area.

The object information includes, for example, information such as a relative position of the object with respect to vehicle V, a relative speed of the object with respect to vehicle V.

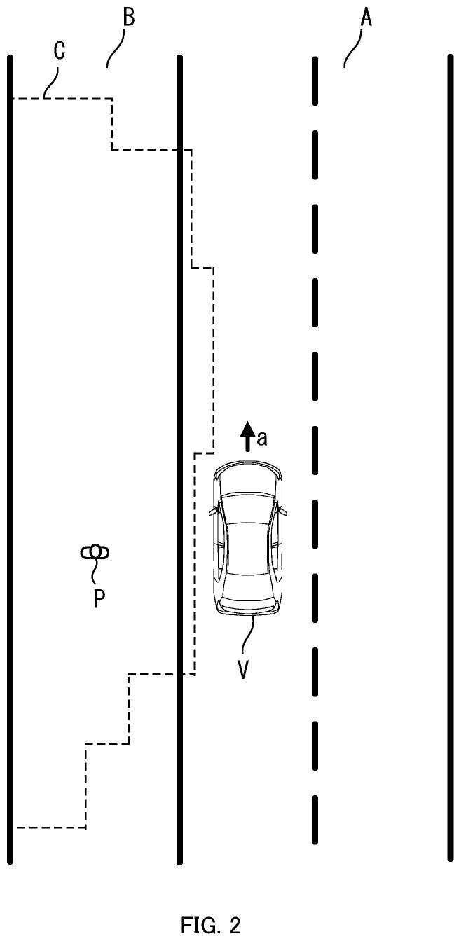

Here, an example of a pull-over area and an object recognized by recognition device 300 will be described with reference to FIG. 2. FIG. 2 is a schematic top-view of an example of pull-over area C and pedestrian P (an example of an object).

In FIG. 2, roadway A is a road having a left side vehicle traffic lane and a right side vehicle traffic lane. Vehicle V is traveling on the left side vehicle traffic lane in the direction indicated by arrow a.

In FIG. 2, pedestrian and bicycle road B is a road adjacent to roadway A.

Pull-over area C includes a portion of roadway A and a portion of pedestrian and bicycle road B. In the example of FIG. 2, pedestrian P is present in pull-over area C. Pedestrian P is, for example, moving in the same direction as the moving direction of vehicle V. The shape and the size of pull-over area C are not limited to those described in FIG. 2.

Recognition device 300 mounted on vehicle V recognizes pull-over area C, and outputs the pull-over area information of pull-over area C to pull-over control apparatus 100.

Further, recognition device 300 mounted on vehicle V recognizes pedestrian P present in pull-over area C, and outputs the object information on pedestrian P to pull-over control apparatus 100.

The example of the pull-over area and the object recognized by recognition device 300 has been described above. Hereinafter, the description returns to FIG. 1.

Error detection device 400 is a device for detecting an abnormality in vehicle V. The abnormality includes, for example, a state in which a device (for example, peripheral detection device 200 described above) for obtaining information necessary for execution of automated driving is broken, a state in which a device for executing acceleration/deceleration, steering, or braking of vehicle V is broken, a state in which an occupant of vehicle V is unconscious, a state in which an occupant of vehicle V is dead, or the like. Error detection device 400 outputs the abnormality information as the detection result to pull-over control apparatus 100. Note that, since the detection technique by abnormality detection device 400 is a publicly known technique, a detailed description thereof is omitted.

Automated driving control device 500, is a device for causing vehicle V to execute automated driving by controlling actuator group 600 to be described later. Note that automated driving control device 500 may control acceleration/deceleration, braking, and steering of vehicle V, or may control some of them.

However, automated driving control device 500 does not control acceleration/deceleration, braking, and steering related to pull-over of vehicle V. Acceleration/deceleration, braking, and steering related to pull-over of vehicle V are controlled by pull-over control apparatus 100 to be described later. Therefore, automated driving control device 500 causes vehicle V to execute automated driving other than pull-over, and pull-over control device 100 causes vehicle V to execute pull-over in this embodiment.

Note that a case where vehicle V is equipped with automated driving control device 500 will be described as an example in the embodiment, but a driving support device that supports a driving operation (e.g., at least one of an acceleration/deceleration operation and an steering operation) of the driver may be installed instead of automated driving control device 500.

Further, abnormality detection device 400 may be a driver monitoring device that detects drowsiness of the driver or a sudden sickness of the driver in such a degree that normal driving cannot be performed. The driver monitoring device outputs the abnormality information as a detection result to pull-over control apparatus 100 when detecting an abnormality of the driver such as drowsiness and/or a sudden sickness while vehicle V is driven by a manual operation of the driver.

Actuator group 600 is an actuator group that executes acceleration, deceleration, braking, steering, and the like of vehicle V. Actuator group 600 includes various actuators, for example, such as a motor actuator that performs acceleration and deceleration, a brake actuator that performs braking, and a steering actuator that performs steering.

Pull-over control apparatus 100 is a device for causing vehicle V to execute pull-over as described above. Pull-over control apparatus 100 is a unit different from automated driving control device 500.

As illustrated in FIG. 1, pull-over control apparatus 100 includes input 110 and controller 120.

Input 110 receives the abnormality information from abnormality detection device 400. In addition, input110 receives pull-over area information and object information from recognition device 300. Then, input 110 outputs the information to controller 120.

Controller 120 performs the following processes based on the pull-over area information and the object information received from input 110, using the reception of the abnormality information from input 110 as a trigger.

Here, an example of the processing performed by controller 120 will be described with reference to FIGS. 2 and 3 to 8. Here, a case where vehicle V present in roadway A illustrated in FIG. 2 is to be pulled over to pull-over area C illustrated in FIG. 2 will be described as an example.

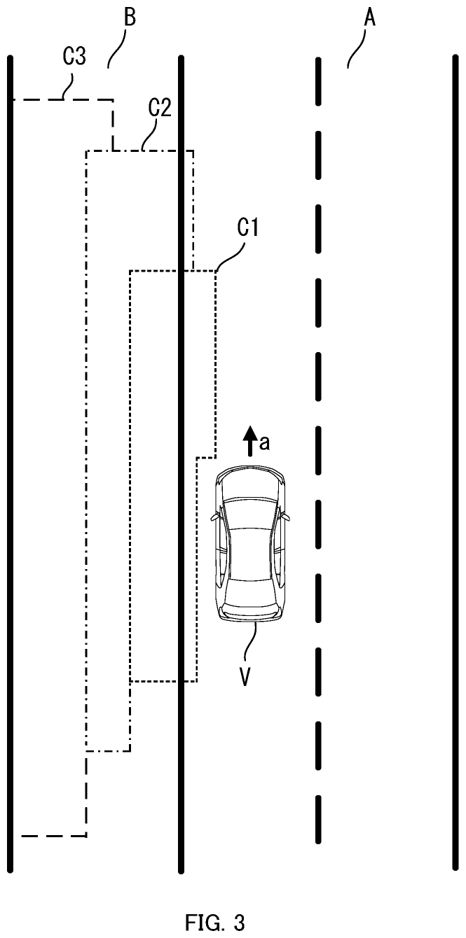

First, controller 120 recognizes pull-over area C (see FIG. 2) indicated in the pull-over area information while dividing into a plurality of partial areas C1 to C3 as illustrated in FIG. 3.

Partial area C1 is an area closest to vehicle V and includes a portion of roadway A and a portion of pedestrian and bicycle road B. Partial area C2 is an area adjacent to the first partial area C1 and includes a portion of roadway A and a portion of pedestrian and bicycle road B. Partial area C3 is an area adjacent to the second partial area C2 and includes a portion of pedestrian and bicycle road B.

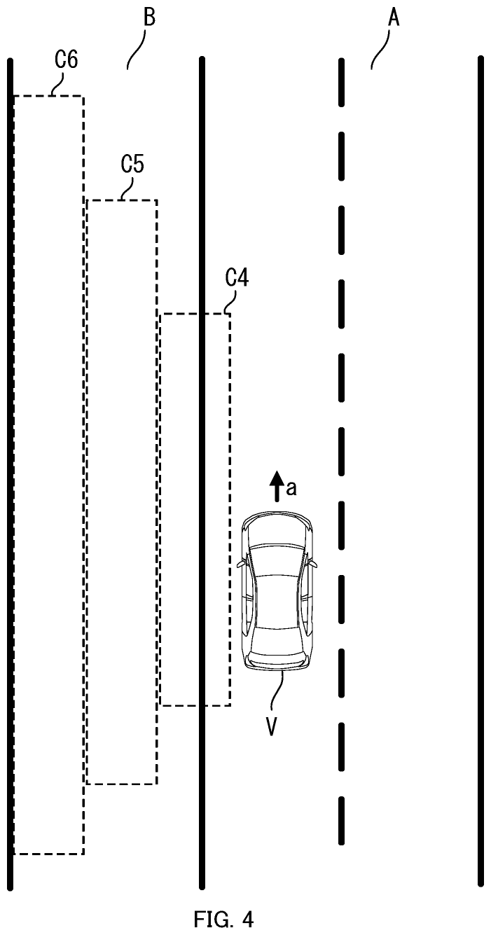

Note that the shape, the size, and the number of the partial areas are not limited to those illustrated in FIG. 2. For example, as illustrated in FIG. 4, pull-over area C may be divided into rectangular partial areas C4 to C6.

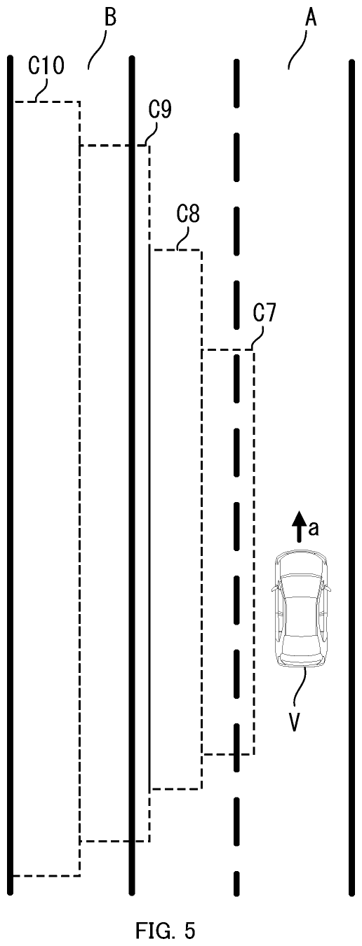

Further, although not illustrated, for example, when vehicle V is traveling on the right side vehicle traffic lane of roadway A, the pull-over area recognized by recognition device 300 may have a size that exceeds the boundary line of the vehicle traffic lanes of roadway A (e.g., dashed white line). In this case, as illustrated in FIG. 5, the pull-over area may be divided into rectangular partial areas C7 to C10. Partial area C7 is an area that includes a portion of the right side vehicle traffic lane and a portion of the left side vehicle traffic lane. Partial area C8 is an area that includes a portion of the left side vehicle traffic lane.

In addition, the number of divisions (in other words, the number of partial areas) of pull-over area C may be set in advance, or may be determined by controller 120 in accordance with the width of pull-over area C (the length in the left-right direction in FIGS. 3 to 5).

Moreover, the shape and the size of the partial areas may be set in advance, or may be determined by controller 120 in accordance with the shape and the size of the pull-over area C. However, it is preferred that the partial areas be determined to have a shape and size including an area in which an object may be present on the lateral and rear side of vehicle V.

Next, controller 120 determines a range in which vehicle V can be pulled over (hereinafter, referred to as a pull-over possible range) among partial areas C1 to C3 based on the object information. This determination is performed, for example, in the order (ascending order) of partial areas C1, C2, and C3.

First, controller 120 determines whether an object is present in partial area C1.

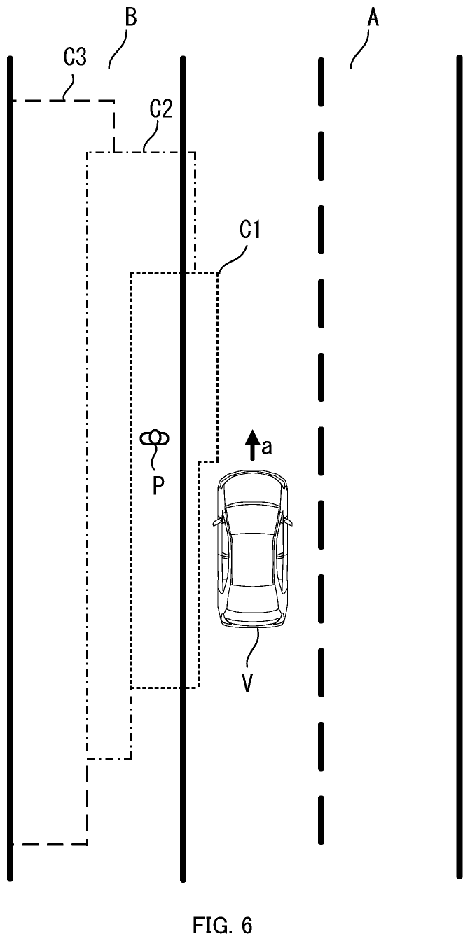

Here, for example, as illustrated in FIG. 6, when pedestrian P is present in partial area C1, controller 120 determines that there is no pull-over possible range. In this case, controller 120 controls actuator group 600 so that vehicle V continues traveling (e.g., traveling straight). Thereafter, when input 110 receives new pull-over area information and new object information from recognition device 300, controller 120 divides the pull-over area again based on the information, and continues the determination of the presence or absence of an object in each partial area, or stops the vehicle.

On the other hand, when an object is not present in partial area C1, controller 120 determines whether an object is present in partial area C2.

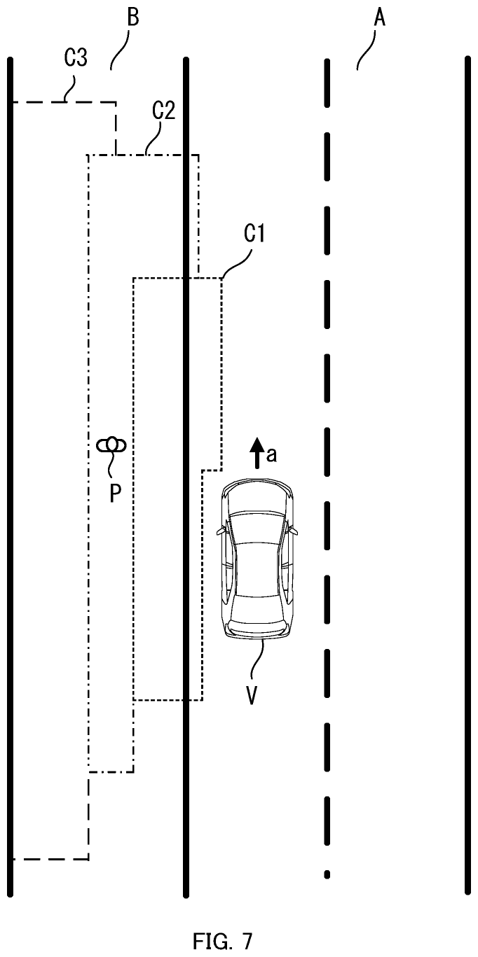

Here, for example, as illustrated in FIG. 7, when pedestrian P is present in partial area C2, controller 120 determines that the pull-over possible range is partial area C1. Then, controller 120 controls actuator group 600 so that vehicle V enters partial area C1 and stops in partial area C1. This control allows vehicle V to enter partial area C1 from roadway A, travel straight along the longitudinal direction of partial area C1, ant then travel straight in partial area C1. This completes the pull-over of vehicle V into partial area C1. Thereafter, when input 110 receives new pull-over area information and new object information from recognition device 300, controller 120 divides the pull-over area again based on the information, and continues the determination of the presence or absence of an object in each partial area, or stops vehicle V by controlling actuator group 600.

On the other hand, when no object is present in partial area C2, controller 120 determines whether an object is present in partial area C3.

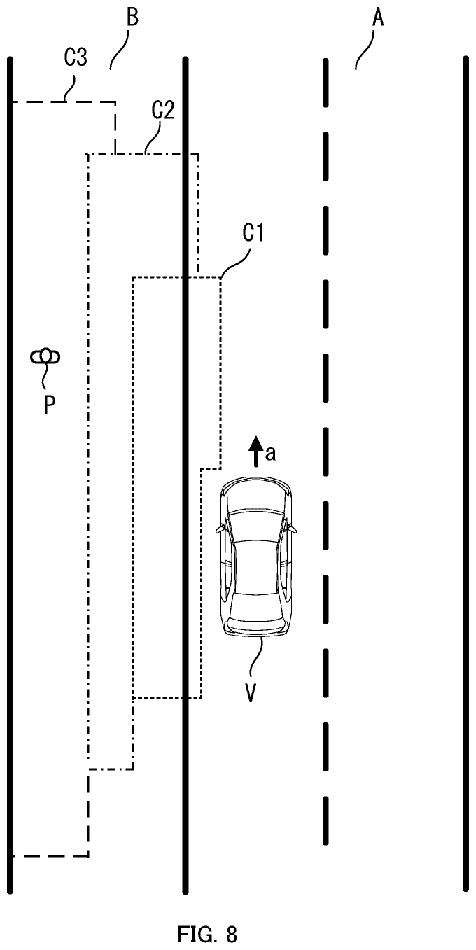

Here, for example, as illustrated in FIG. 8, when pedestrian P is present in partial area C3, controller 120 determines that the pull-over possible range is partial areas C1 and C2. Then, controller 120 controls actuator group 600 so that vehicle V enters partial area C2 through partial area C1 and stops in partial area C2. This control allows vehicle V to enter partial area C2 through partial area C 1 from roadway A, travel straight along the longitudinal direction of partial area C2, and then travel straight in partial area C2. This completes the pull-over of vehicle V into partial area C2. Thereafter, when input 110 receives new pull-over area information and new object information from recognition device 300, controller 120 divides the pull-over area again based on the information, and continues the determination of the presence or absence of an object in each partial area, or stops vehicle V by controlling actuator group 600.

On the other hand, when no object is present in partial area C3, controller 120 determines that the pull-over possible range is partial areas C1, C2, and C3. Then, controller 120 controls actuator group 600 so that vehicle V enters partial area C3 through partial areas C1 and C2 and stops in partial area C3. This control allows vehicle V to enter partial area C3 through partial areas C1 and C2 from roadway A, travel straight along the longitudinal direction of partial area C3, and then travel straight in partial area C3. This completes the pull-over of vehicle V into partial area C3. Thereafter, when input 110 receives new pull-over area information and new object information from recognition device 300, controller 120 divides the pull-over area again based on the information, and continues the determination of the presence or absence of an object in each partial area, or stops vehicle V by controlling actuator group 600.

The example of the processing performed by controller 120 has been described above.

Pull-over control apparatus 100, recognition device 300, abnormality detection device 400, and automated driving control device 500 described above are realized by, for example, an Electronic Control Unit (ECU). However, as described above, since pull-over control apparatus 100 and automated driving control device 500 are units different from each other, the ECU for realizing pull-over control apparatus 100 is provided separately from the ECU for realizing automated driving control device 500. Note that, for example, recognition device 300 and pull-over control apparatus 100 may be realized by the same ECU.

The configuration of vehicle V and pull-over control apparatus 100 has been described above.

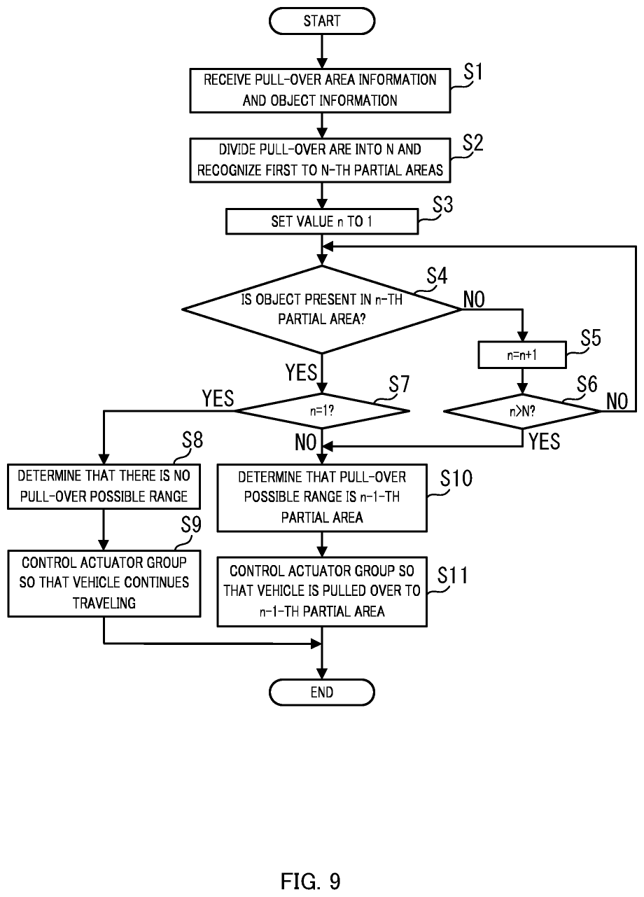

Next, with reference to FIG. 9, the operation flow of pull-over control apparatus 100 will be described. FIG. 9 is a flowchart of the operation flow of pull-over control apparatus 100.

As described above, the flowchart described in FIG. 9 starts when pull-over control apparatus 100 receives abnormality information from abnormality detection device 400 (in other words, when any abnormality that interferes with the continuation of automated driving of vehicle V occurs).

First, input 110 receives pull-over area information and object information from recognition device 300 (step S1). Then, input 110 outputs the pull-over area information and the object information to controller 120.

Next, controller 120 divides the pull-over area indicated in the pull-over area information into N (N is an integer of 2 or more) partial areas and recognizes the first to N-th partial areas (step S2).

Here, the first partial area is a partial area closest to vehicle V (e.g., partial area C1 illustrated in FIG. 3). The N-th partial area is a partial area farthest from vehicle V (e.g., partial area C3 illustrated in FIG. 3).

Next, controller 120 sets value n to 1 (Step S3). The value n represents the partial area that is to be a determination target in step S4 to be described later.

Next, controller 120 determines whether an object is present in the n-th partial area based on the object information (Step S4).

When no object is present in the n-th partial area (step S4: NO), controller 120 increments n by one (step S5), and determines whether n>N is satisfied (step S6).

When n>N is satisfied (step S6: YES), the processing proceeds to step S10 to be described later.

When n>N is not satisfied (step S6: NO), the processing returns to step S4.

When an object is present in the n-th partial area (step S4: YES), controller 120 determines whether n is 1 (step S7).

When n is 1 (step S7: YES), controller 120 determines that there is no pull-over possible range (step S8).

Then, controller 120 controls actuator group 600 so that vehicle V continues traveling (step S9). Thereafter, the processing may be repeated from step S1. In this case, as described above, input 110 receives new pull-over area information and new object information from recognition device 300 (step S1), and controller 120 performs processes of step S2 and the subsequent steps based on the new pull-over area information and the new object information.

When n is not 1 (step S7: NO), controller 120 determines that the pull-over possible range is n-1-th partial area (step S10).

Controller 120 controls actuator group 600 so that vehicle V is pulled over to the n-1-th partial area (step S11). Thereafter, the processing may be repeated from step S1.

The operation flow of pull-over control apparatus 100 has been described above.

As described in detail above, pull-over control apparatus 100 of the present embodiment includes: input 110 that receives information on pull-over area C determined as a pull-over area for vehicle V present in roadway A and information on an object (e.g., pedestrian P) recognized in pull-over area C; and controller 120 that recognizes pull-over area C while dividing pull-over area C into a plurality of partial areas (e.g., first partial area C1 to third partial area C3) including at least first partial area C1 closest to the vehicle and second partial area C2 adjacent to first partial area C1, determines a first range in which vehicle V can be pulled over among the plurality of partial areas (e.g., any of first partial area C1 to third partial area C3) based on the object information, and controls vehicle V so that vehicle V pulls over into the first range.

Therefore, pull-over control apparatus 100 according to the present embodiment can reduce the amount of calculation related to pulling over as compared with the conventional pull-over control apparatus (e.g., the apparatus disclosed in PTL 1), and can reduce the cost.

Further, pull-over control apparatus 100 of the present embodiment is provided independently of automated driving control device 500, and thus can be provided at low cost.

In addition, in pull-over control apparatus 100 of the present embodiment, vehicle V is not required to wait for movement of the object in order to avoid colliding with the object. Therefore, pull-over control apparatus 100 of the present embodiment can realize rapid pull-over and can improve the safety.

Note that the present disclosure is not limited to the description of the above embodiment, and various variations can be made without departing from the spirit thereof Hereinafter, variations will be described.

[Variation 1]

The size of the pull-over area may be determined in accordance with the speed of vehicle V. For example, recognition device 300 may determine the pull-over area so that the higher the speed of the vehicle V, the larger the area in front of vehicle V.

[Variation 2]

After vehicle V enters any of the partial areas, pull-over control apparatus 100 may further divide a partial area adjacent to the entering partial area, and pull-over vehicle V to any of the partial areas.

For example, after vehicle V enters partial area C2 illustrated in FIG. 3, controller 120 recognizes partial area C3 by further dividing partial area C3 into a plurality of partial areas. Then, controller 120 determines a pull-over possible range in which vehicle V can be pulled over among the further divided partial areas, and controls actuator group 600 so that vehicle V is pulled over to the range.

[Variation 3]

Pull-over control apparatus 100 may perform a series of processes described in FIG. 9 again after vehicle V enters any of the partial areas.

Hereinafter, a case where partial area C3 among partial areas C1 to C3 illustrated in FIG. 3 is determined as the pull-over possible range will be described as an example.

Input 110 receives, after vehicle V enters partial area C3, pull-over area information indicating a new pull-over area determined as a new pull-over area of vehicle V and object information indicating a new object recognized in the new pull-over area. Although not illustrated, the new pull-over area is an area adjacent to partial area C3 (e.g., the area outside pedestrian and bicycle road B in FIG. 3).

Controller 120 recognizes the new pull-over area indicated by the pull-over area information, while dividing the pull-over area into a plurality of partial areas including at least a partial area adjacent to partial area C3 and a partial area adjacent to the partial area. Then, controller 120 determines a range into which vehicle V can be pulled over among the new plurality of partial areas based on the object information, and controls actuator group 600 so that vehicle V is pulled over in the range.

Note that the processing of controller 120 described above may be executed when vehicle V is traveling straight in partial area C3 along the longitudinal direction thereof

The variations of the present disclosure have been described above. The variations described above may be implemented in combination.

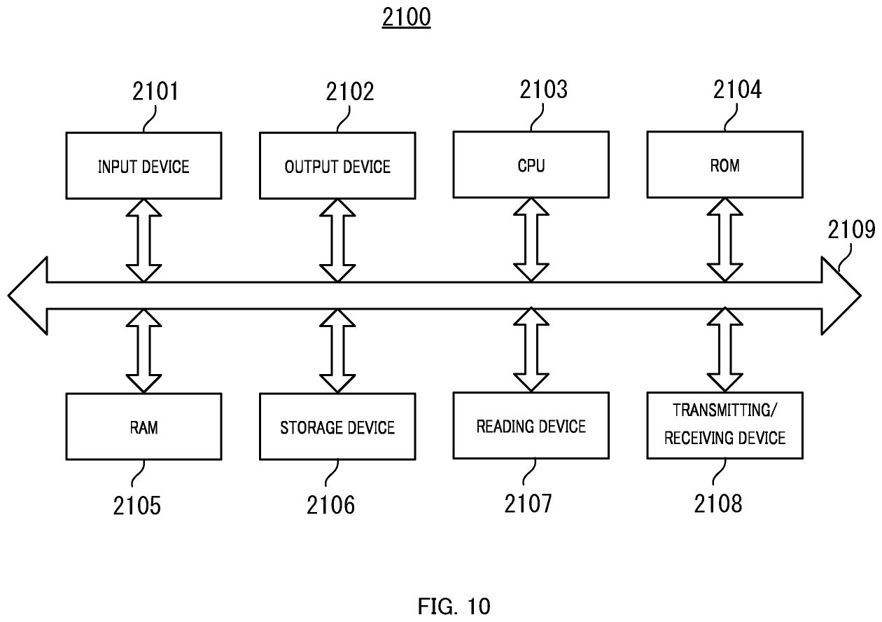

The function of each unit in the embodiment and each variation may be realized by a program. An example of a hardware configuration of the computer in this case is described in FIG. 10.

As described in FIG. 10, computer 2100 includes input device 2101 such as an input button and a touch pad, output device 2102 such as a display and a speaker, Central Processing Unit (CPU) 2103, Read Only Memory (ROM) 2104, and Random Access Memory (RAM) 2105. Computer 2100 includes storage device 2106 such as a hard disk drive, a Solid State Drive (SSD), reading device 2107 for reading information from a recording medium such as a Digital Versatile Disk Read Only Memory (DVD-ROM) and a Universal Serial Bus (USB) memory, and transmitting/receiving device 2108 for communicating through a network. The above-described components are connected with each other by bus 2109.

Accordingly, reading device 2107 reads a program from recording medium that records the program for realizing the function of each unit, and records the program in storage device 2106. Alternatively, transmitting/receiving device 2108 communicates with a server device connected to the network, and stores a program for realizing the function of each unit downloaded from the server device in storage device 2106.

Then, CPU 2103 copies the program stored in storage device 2106 to RAM 2105, sequentially reads out the instructions included in the program from RAM 2105 to execute the program, and thus the function of each unit is realized. When the program is executed, RAM 2105 or storage device 2106 stores the information obtained in the various processes described in the embodiment and the variations, and the information is used as appropriate.

<Summary of the Present Disclosure>

The pull-over control apparatus of the present disclosure includes: an input that receives information on a pull-over area determined as a pull-over destination for a vehicle present on a roadway and information on an object recognized in the pull-over area; and a controller that recognizes the pull-over area while dividing the pull-over area into a plurality of partial areas, based on the information on the pull-over area, the plurality of partial areas including at least a first partial area closest to the vehicle and a second partial area adjacent to the first partial area, the controller controlling, based on the information on the object, the vehicle so that the vehicle is pulled over to a first range where pull-over of the vehicle is possible among the plurality of the partial areas.

In the pull-over control apparatus of the present disclosure, the controller determines a number of divisions of the pull-over area in accordance with a width of the pull-over area.

In the pull-over control apparatus of the present disclosure, the input receives information on a new pull-over area determined as a new pull-over area for the vehicle and information on a new object recognized in the new pull-over area after the vehicle enters the first range; and the controller, based on the information on the new pull-over area, recognizes the new pull-over area while dividing the new pull-over area into a plurality of new partial areas including at least a third partial area adjacent to the first range and a fourth partial area adjacent to the third partial area, and controls, based on the information on the new object, the vehicle so that the vehicle is pulled over to a second range where pull-over of the vehicle is possible among the plurality of the new partial areas.

In the pull-over control apparatus of the present disclosure, the controller executes a process based on the information on the new pull-over area and the information on the new object when the vehicle is traveling straight in the first range.

In the pull-over control apparatus of the present disclosure, a size of the pull-over area is determined in accordance with a speed of the vehicle.

The vehicle of the present disclosure includes the pull-over control apparatus of the present disclosure.

The vehicle of the present disclosure further includes a recognition device that determines a size of the pull-over area in accordance with a speed of the vehicle.

The vehicle of the present disclosure further includes an abnormality detection device that detects an abnormality, and in the vehicle of the present disclosure, the pull-over control apparatus executes determination of the first range and pulls over the vehicle to the first range when the abnormality is detected by the abnormality detection device.

The pull-over control method of the present disclosure includes: receiving information on a pull-over area determined as a pull-over destination for a vehicle present on a roadway and information on an object recognized in the pull-over area; recognizing the pull-over area while dividing the pull-over area into a plurality of partial areas based on the information on the pull-over area, the plurality of partial areas including at least a first partial area closest to the vehicle and a second partial area adjacent to the first partial area; and controlling, based on the information on the object, the vehicle so that the vehicle is pulled over to a range where pull-over of the vehicle is possible among the plurality of the partial areas.

The disclosure of Japanese Patent Application No. 2019-236226, filed on Dec. 26, 2019, including the specification, drawings and abstract, is incorporated herein by reference in its entirety.

### INDUSTRIAL APPLICABILITY

The pull-over control apparatus, the vehicle, and the pull-over control method of the present disclosure can be applied to the overall technique for pulling over a vehicle.

### REFERENCE SIGNS LIST

100 Pull-over control apparatus
110 Input
120 Controller
200 Peripheral detection device
300 Recognition device
400 Error detection device
500 Automated driving control device
600 Actuator group
2100 Computer
2101 Input device
2102 Output device
2103 CPU
2104 ROM
2105 RAM
2106 Storage device
2107 Reading device
2108 Transmitting/receiving device
2109 Bus

1. A pull-over control apparatus, comprising:
an input that receives information on a pull-over area determined as a pull-over destination for a vehicle present on a roadway and information on an object recognized in the pull-over area; and
a controller that recognizes the pull-over area while dividing the pull-over area into a plurality of partial areas, based on the information on the pull-over area, the plurality of partial areas including at least a first partial area closest to the vehicle and a second partial area adjacent to the first partial area, the controller controlling, based on the information on the object, the vehicle so that the vehicle is pulled over to a first range where pull-over of the vehicle is possible among the plurality of the partial areas.

2. The pull-over control apparatus according to claim 1, wherein
the controller determines a number of divisions of the pull-over area in accordance with a width of the pull-over area.

3. The pull-over control apparatus according to claim 1, wherein
the input receives information on a new pull-over area determined as a new pull-over area for the vehicle and information on a new object recognized in the new pull-over area after the vehicle enters the first range; and
the controller, based on the information on the new pull-over area, recognizes the new pull-over area while dividing the new pull-over area into a plurality of new partial areas including at least a third partial area adjacent to the first range and a fourth partial area adjacent to the third partial area, and
controls, based on the information on the new object, the vehicle so that the vehicle is pulled over to a second range where pull-over of the vehicle is possible among the plurality of the new partial areas.

4. The pull-over control apparatus according to claim 3, wherein
the controller executes a process based on the information on the new pull-over area and the information on the new object when the vehicle is traveling straight in the first range.

5. The pull-over control apparatus according to claim 1, wherein
a size of the pull-over area is determined in accordance with a speed of the vehicle.

6. A vehicle comprising the pull-over control apparatus according to claim 1.

7. The vehicle according to claim 6, further comprising
a recognition device that determines a size of the pull-over area in accordance with a speed of the vehicle.

8. The vehicle according to claim 6, further comprising an abnormality detection device that detects an abnormality, wherein
the pull-over control apparatus executes determination of the first range and pulls over the vehicle to the first range when the abnormality is detected by the abnormality detection device.

9. A pull-over control method, comprising:
receiving information on a pull-over area determined as a pull-over destination for a vehicle present on a roadway and information on an object recognized in the pull-over area;
recognizing the pull-over area while dividing the pull-over area into a plurality of partial areas based on the information on the pull-over area, the plurality of partial areas including at least a first partial area closest to the vehicle and a second partial area adjacent to the first partial area; and
controlling, based on the information on the object, the vehicle so that the vehicle is pulled over to a range where pull-over of the vehicle is possible among the plurality of the partial areas.
